(19) United States
(12) Patent Application Publication
(10) Pub. No.: US 2019/0011310 A1
(43) Pub. Date: Jan. 10, 2019

(54) SYSTEM AND METHOD FOR VIBRATION COMPLIANCE MONITORING

(71) Applicant: Stanley Convergent Security Solutions, Inc., Naperville, IL (US)

(72) Inventors: Robert C. Turnbull, Ottawa (CA); Terance D. Brown, White Lake (CA); Steven C. Van Eyk, Kanata (CA)

(21) Appl. No.: 16/064,642

(22) PCT Filed: Jun. 30, 2016
(86) PCT No.: PCT/US16/40313

§ 371 Date: Jun. 21, 2018

Related U.S. Application Data
(60) Provisional application No. 62/306,132, filed on Mar. 10, 2016.

(51) Int. Cl. G01H 1/06; G01M 7/02

(52) U.S. Cl. CPC G01H 1/06; G01M 7/02

(57) ABSTRACT

A vibration monitoring system with vibration sensors, a computer system connected to the vibration sensors, and a display connected to the computer system. The computer system gathers data from the vibration sensors and compares the gathered data to a first threshold. The display shows a first list of events where the gathered data exceed the first threshold. The computer system has a local computer connected to the vibration sensors, and a central monitoring station and/or a user computer connected to the local computer. The central monitoring station and/or the user computer is connected to the local computer via the Internet.

### CROSS-REFERENCE TO RELATED APPLICATION

This application derives priority from U.S. Patent Application No. 62/306,132, entitled “SYSTEM AND METHOD FOR VIBRATION COMPLIANCE MONITORING,” filed Mar. 10, 2016, now pending, and is hereby wholly incorporated by reference.

### FIELD OF THE INVENTION

The present invention relates to vibration detection and compliance monitoring, and in particular, to vibration detection and compliance monitoring for construction projects and/or industrial activities.

### BACKGROUND

Local, state and/or federal regulations may limit the generation of vibrations in construction projects and/or industrial activities. In particular, the regulations may require the monitoring for continuous and/or transient vibrations in such locales. In addition, the regulations may also require providing proof of compliance with the regulation vibration limits.

It is desirable to provide a system that can monitor for continuous and/or transient vibrations in such locales.

### BRIEF DESCRIPTION OF THE DRAWINGS

FIG. 1 illustrates a vibration monitoring system.

FIG. 2 is a flowchart for the vibration monitoring process.

FIG. 3 illustrates a display showing the output of the vibration monitoring process.

### DESCRIPTION

Referring to FIG. 1, a vibration monitoring system 100 may include a plurality of vibration sensors 101, such as ground geophones, air-overpressure sensors, etc. Such sensors 101 are connected to a local computer or server 102.

Local computer 102 is preferably connected to a central monitoring station or server 104. Such connection may be via a hard-wired network or via the internet 103. Local computer 102 may analyze the signals received from sensors 101, in the manner discussed below.

Central monitoring station 104 may receive the data from sensors 101 provided by local computer 102. Central monitoring station 104 may also analyze the data in the manner discussed below. Alternatively central monitoring station 104 may only receive the data analysis results instead of the signal data from sensors 101.

Depending upon the data analysis results, local computer 102 and/or central monitoring station 104 may log (or store) the results in a list. A user would be able to view such results and/or list in a separate user computer 105, such as a laptop, smartphone, tablet, etc. The user computer 105 is preferably connected to local computer 102 and/or central monitoring station 104 via a hard-wired network or internet 103.

An alarm 106, such as a light fixture and/or siren, etc. may be connected to local computer 102. Local computer 102 can activate such alarm 106 depending upon the data analysis results.

Such alarm 106 may also be connected to and/or remotely controlled by central monitoring station 104. With such arrangement, central monitoring station 104 can activate such alarm 106 depending upon the data analysis results.

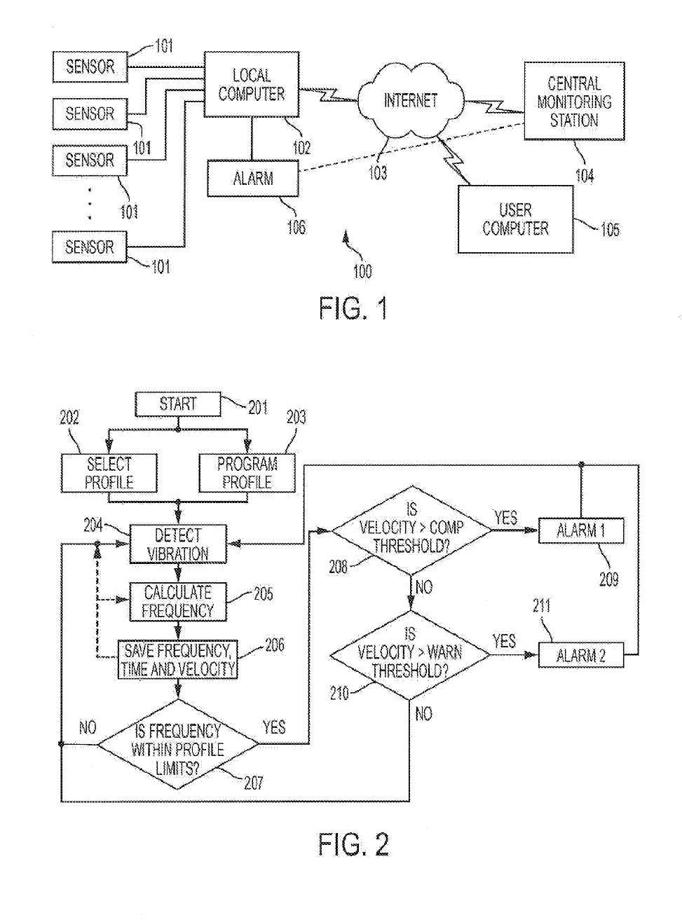

FIG. 2 shows the steps taken in analyzing and monitoring the data from sensors 101. The method begins at the starting step 201. The user can select a vibration compliance profile (step 202) from a list of profiles, each profile providing a compliance curve that meets the requirements of a particular local, state or federal rule or regulation.

Alternatively, the user can create a compliance curve by programming or selecting the different limit vibration parameters (step 203). This compliance curve would be different from the required compliance curve. Such compliance curve, for example, may have lower thresholds than the required compliance curve in order to meet specific job requirements.

Once the compliance curve is selected and/or programmed, system 100 can monitor and detect vibration (step 204) via sensors 101. Once vibration is detected, it can be analyzed. Preferably the different frequencies of a vibration event can be calculated (step 205). Local computer 102 and/or central monitoring station 104 could receive the vibration event data in waveform and/or histogram form over time. Such data preferably includes the transverse, longitudinal and vertical vibration data points.

By analyzing the velocity and time data from the vibration event, the first change in polarity (i.e., a zero crossing) of the velocity component can be determined and stored. Persons skilled in the art will recognize that, in addition to storing the velocity data, it is helpful to store the time signature for such first change.

The local computer 102 and/or central monitoring station 104 preferably continue to analyze the velocity and time data to identify another change in the polarity of the velocity component. The particular frequency can thus be calculated using the following equation:

Frequency=0.5/(T2−T1),

where T1 and T2 are the time signatures of the first and second polarity changes, respectively.

The calculated frequency, with the corresponding time signature, velocity and channel data, are stored (step 206). The system can then continue to detect further vibration events (step 204) and/or analyze the remaining data about the vibration event until all the zero crossing points are found (step 205).

The system can further analyze the stored data in view of the compliance profiles on the fly (i.e., right after the vibration event has been detected and analyzed) or at a later time after the vibration event has occurred. In such analysis, the local computer 102 and/or central monitoring station 104 would review each stored frequency/time/velocity data set.

For example, the local computer 102 and/or central monitoring station 104 would review each stored frequency/time/velocity data set and determine whether the frequency for the particular data set was within the minimum and maximum frequencies called for by the particular compliance profile (step 207). If not, the system can then continue to detect further vibration events (step 204) or analyze the remaining stored frequency/time/velocity data sets.

If the frequency for the particular data set was within the minimum and maximum frequencies called for by the particular compliance profile, then the local computer 102 and/or central monitoring station 104 would review the corresponding velocity for each channel in the data set. For example, the local computer 102 and/or central monitoring station 104 could review the corresponding velocity in each channel from the data set to determine whether the velocity magnitude was larger than the velocity allowed under the compliance profile, i.e., an alarm threshold (step 208).

If the velocity is higher than the alarm threshold, local computer 102 and/or central monitoring station 104 could activate alarm 106 (step 209). As part of the alarm step, local computer 102 and/or central monitoring station 104 could store an alarm note for such data set to be displayed in a list as discussed below, send an email or text notification to the user, send a software app notification that would display in the user's computer 105, etc. Thereafter, the system can then continue to detect further vibration events (step 204) or analyze the remaining stored frequency/time/velocity data sets.

If the velocity is not higher than the alarm threshold, local computer 102 and/or central monitoring station 104 could review the corresponding velocity for each channel from the data set to determine whether the velocity magnitude was larger than a predetermined velocity threshold, i.e., a warning threshold, which is preferably lower than the alarm threshold (step 210).

If the velocity is higher than the warning threshold, local computer 102 and/or central monitoring station 104 activate alarm 106 (step 211). As part of the alarm step, local computer 102 and/or central monitoring station 104 could store a warning note for such data set to be displayed in a list as discussed below, send an email or text notification to the user, send a software app notification that would display in the user's computer 105, etc. Thereafter, the system can then continue to detect further vibration events (step 204) or analyze the remaining stored frequency/time/velocity data sets.

If the velocity is not higher than the alarm threshold, the system can then continue to detect further vibration events (step 204) or analyze the remaining stored frequency/time/velocity data sets.

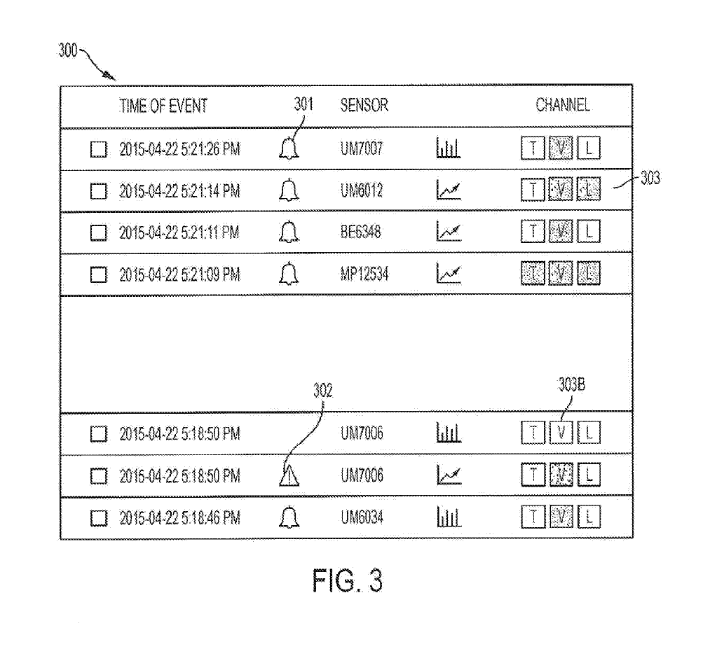

FIG. 3 shows a list 300 of vibration events that can be displayed on the local computer 102, central monitoring station 104 and/or user computer 105. Such list 300 includes a list of vibration events, with the time of the event, an identification of the sensor 101 that detected the vibration, and a channel display 303. Icons 301, 302 may be placed next to particular events to identify events that exceeded the alarm threshold and warning threshold, respectively.

The channel display 303 graphically shows the three channels (transverse, longitudinal and vertical) for each vibration event, where boxes 303B with the T, V and L letters correspond to the transverse, vertical and longitudinal channels, respectively. Channel display 303 may also show the channels where the vibrations exceeded the alarm threshold and warning threshold.

For example if the vibration along the vertical channel exceeded the alarm threshold, the box 303B with the V letter would be preferably colored red or black (as shown in the first line of the list shown in FIG. 3). Alternatively, if the vibration along the vertical channel exceeded the warning threshold, the box 303B with the V letter would be preferably colored orange or gray (as shown in the sixth line of the list shown in FIG. 3). If the vibration along the vertical channel exceeded both the alarm threshold and the warning threshold, the box 303B with the V letter would preferably be partly colored red or black and partly colored orange or gray (as shown in the second line of the list shown in FIG. 3). If the vibration along the longitudinal channel did not exceed the alarm threshold or warning threshold, the box 303B with the V letter would preferably be colored white (as shown in the first line of the list shown in FIG. 3).

List 300 may also provide the detailed data next to the channel display 303, such as the velocity data, frequency, etc. Alternatively users may see the detailed data for each channel if they click on the channel or hover over the selected box 303B.

The description of the invention is merely exemplary in nature and, thus, variations that do not depart from the gist of the invention are intended to be within the scope of the invention. Such variations are not to be regarded as a departure from the scope of the invention.

What is claimed is:

1: A vibration monitoring system comprising:
a plurality of vibration sensors;
a computer system connected to the plurality of vibration sensors; and
a display connected to the computer system;
wherein the computer system gathers data from the plurality of vibration sensors, compares the gathered data to a first threshold, and
the display showing a first list of events where the gathered data exceed the first threshold.

2: The vibration monitoring system of claim 1 wherein the computer system comprises a local computer connected to the plurality of vibration sensors.

3: The vibration monitoring system of claim 2 wherein the computer system comprises a user computer connected to the local computer.

4: The vibration monitoring system of claim 3 wherein the user computer is connected to the local computer via the Internet.

5: The vibration monitoring system of claim 3 wherein the display is connected to at least one of the user computer and local computer.

6: The vibration monitoring system of claim 3 wherein the computer system comprises a central monitoring station connected to the local computer.

7: The vibration monitoring system of claim 6 wherein the u central monitoring station is connected to the local computer via the Internet.

8: The vibration monitoring system of claim 6 wherein the display is connected to at least one of the central monitoring station, the user computer and local computer.

9: The vibration monitoring system of claim 1 wherein the computer system compares the gathered data to a second threshold, and the display shows a second list of events where the gathered data exceed the second threshold.

10: The vibration monitoring system of claim 8 wherein the display shows the first and second lists of events together in chronological order.

11: The vibration monitoring system of claim 10, wherein each event in the first and second lists includes transverse, longitudinal and vertical vibration information.

12: The vibration monitoring system of claim 1, wherein the first threshold is selectable by a user.

13: The vibration monitoring system of claim 1 further comprising an alarm connected to the computer system.

14: The vibration monitoring system of claim 13, wherein the alarm activates when the gathered data exceed the first threshold.
